(19) United States
(12) Patent Application Publication
(10) Pub. No.: US 2026/0217185 A1
(43) Pub. Date: Jul. 30, 2026

(54) HEADLIGHT CONTROL DEVICE

(71) Applicant: TOYOTA JIDOSHA KABUSHIKI KAISHA, Toyota-shi (JP)

(72) Inventors: Yukimi TAGUCHI, Okazaki-shi (JP); Takuya NOMURA, Aichi-ken (JP); Hisayoshi TACHIKAWA, Toyota-shi (JP)

(73) Assignee: TOYOTA JIDOSHA KABUSHIKI KAISHA, Toyota-shi (JP)

(21) Appl. No.: 19/395,618

(22) Filed: Nov. 20, 2025

(30) Foreign Application Priority Data
Jan. 29, 2025 (JP) 2025-012792

(51) Int. Cl. B60Q 1/14; G06T 7/90; H05B 47/125

(52) U.S. Cl. CPC B60Q 1/143; G06T 7/90; H05B 47/125; B60Q 2300/45; G06T 2207/20072

(57) ABSTRACT

A headlight control device controls headlamps being able to adjust an amount of light for each of a plurality of light distribution regions. The headlight control device includes a high-brightness target recognition unit recognizing a high-brightness target forward of a vehicle based on a captured image from a camera that captures an image of a region forward of the vehicle, and a dimming controller performing, based on a recognition result of the high-brightness target recognition unit, dimming control of reducing an amount of light in a light distribution region including the high-brightness target. The high-brightness target recognition unit recognizes, based on a color component of a target included in the captured image, a target satisfying a high-brightness color component condition that is predetermined as the high-brightness target.

### CROSS-REFERENCE TO RELATED APPLICATION

This application claims priority to Japanese Patent Application No. 2025-012792 filed on January 29, 2025. The disclosure of the above-identified application, including the specification, drawings, and claims, is incorporated by reference herein in its entirety.

### BACKGROUND

### 1. Technical Field

The present disclosure relates to a headlight control device.

### 2. Description of Related Art

In the related art, a device that detects a dimming target object using a reference value set to be different depending on whether an object lies inside or outside a driver's attention area is known for controlling headlights (for example. Japanese Patent No. 7238829 (JP 7238829 B)).

### SUMMARY

In the related art, the dimming target object is detected based on an index value representing brightness of an object forward of an own vehicle. However, even though the object is bright, a driver (user) of the own vehicle may not always feel dazzled depending on a tint of the object. Therefore, there is room for improvement in performing dimming control that is unlikely to cause discomfort to the user.

A headlight control device according to an aspect of the present disclosure is

a headlight control device that controls headlights being able to adjust an amount of light for each of a plurality of light distribution regions, the headlight control device including:

a high-brightness target recognition unit configured to recognize a high-brightness target forward of a vehicle based on a captured image from a capturing device that captures an image of a region forward of the vehicle; and

a dimming controller configured to perform, based on a recognition result of the high-brightness target recognition unit, dimming control of reducing an amount of light in a light distribution region that includes the high-brightness target,

in which the high-brightness target recognition unit is configured to recognize, based on a color component of a target included in the captured image, the target satisfying a predetermined high-brightness color component condition as the high-brightness target.

In the headlight control device according to the aspect of the present disclosure, the high-brightness target recognition unit recognizes the target satisfying the predetermined high-brightness color component condition as the high-brightness target. As described above, since the high-brightness target is recognized based on the color component of the target included in the captured image, it is possible to suppress recognition of a target that is bright but does not cause a user to feel dazzled depending on a tint of the target as the high-brightness target.

In one embodiment,

the high-brightness target recognition unit may be configured to generate, for a plurality of pixels constituting the target on the captured image, for each of the targets, a histogram in which the number of observations of a component value of the color component in each of the pixels is counted, and

the high-brightness color component condition may be satisfied for a target corresponding to a histogram in which a total value of frequencies included in a predetermined range of the component value is equal to or greater than a determination threshold value.

In this case, it is possible to determine whether the high-brightness color component condition is satisfied for each target by using the histogram in which the number of observations of the component value of the color component is counted.

In one embodiment,

the predetermined range may include a first range falling within less than half of the number of gradations of the component value and a second range falling within half or more of the number of gradations of the component value, and

the high-brightness color component condition may be satisfied for a target corresponding to a histogram in which a total value of frequencies included in the first range is equal to or greater than a first determination threshold value and a total value of frequencies included in the second range is equal to or greater than a second determination threshold value.

In this case, by performing determination of the total value of the frequencies in both the first range and the second range having different number of gradations of the component value, it is possible to determine whether the high-brightness color component condition is satisfied with higher precision.

With the headlight control device according to the aspect of the present disclosure, it is possible to suppress the recognition of the target that is bright but does not cause the user to feel dazzled depending on the tint of the target as the high-brightness target.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a headlight control device according to an embodiment;

FIG. 2 is a diagram showing a hardware configuration of an ECU of FIG. 1;

FIG. 3 is a flowchart illustrating processing executed by the ECU of FIG. 1;

FIG. 4 is a flowchart illustrating recognition processing of the high-brightness target of FIG. 3;

FIG. 5 is a diagram illustrating a histogram in which the number of observations of the component value of the color component is counted;

FIG. 6 is a diagram illustrating a histogram of a target different from that of FIG. 5; and

FIG. 7 is a diagram illustrating a histogram of a target different from those of FIGS. 5 and 6.

### DETAILED DESCRIPTION OF EMBODIMENTS

Hereinafter, the embodiment will be described in detail with reference to the accompanying drawings. The same or corresponding elements in the drawings are designated by the same reference numerals, and redundant description thereof will be omitted.

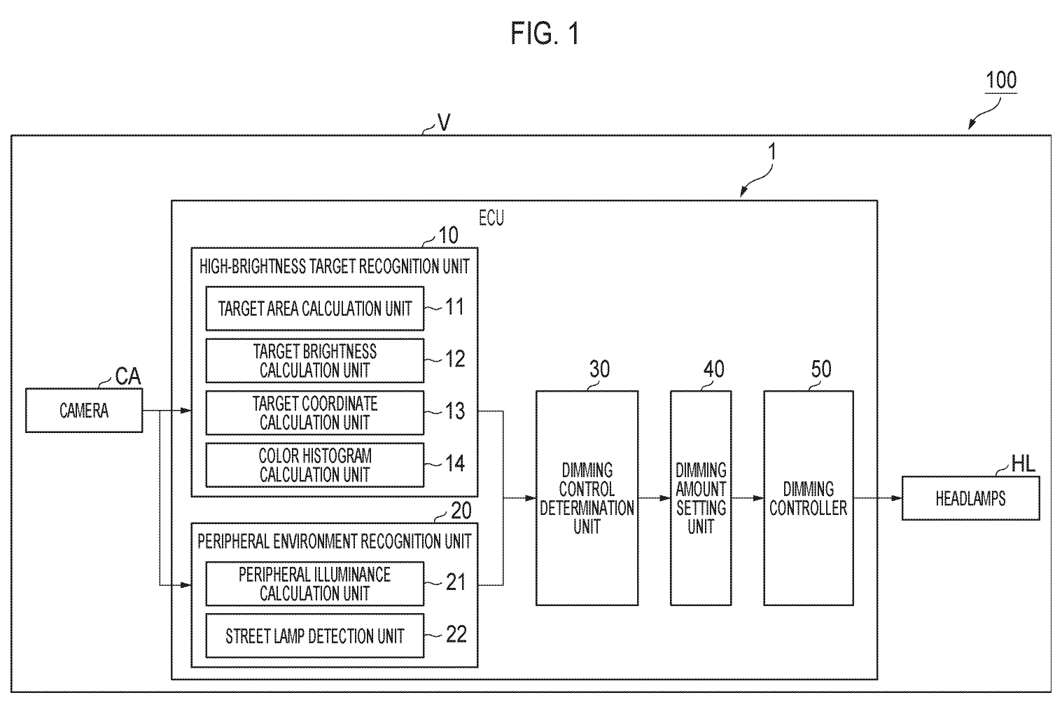

As shown in FIG. 1, a headlight control device 100 according to the embodiment is a device that controls headlamps HL (headlights) of a vehicle V. The vehicle V may be a passenger car or a truck. The vehicle V can accommodate one or a plurality of occupants (users). The vehicle V may be an autonomous driving vehicle capable of autonomous driving. The vehicle V may be capable of manual driving by a driver. The headlight control device 100 has a light distribution control function (for example, an adaptive high beam system [AHS]).

The headlamps HL are lamps that illuminate a region forward of the vehicle V. The headlamps HL are configured to adjust the amount of light for each of a plurality of light distribution regions (irradiation regions). For example, the headlamps HL include a plurality of LEDs arranged side by side, and the irradiation amount in any light distribution region can be increased or decreased by adjusting the energization amount of any LED. The headlight control device 100 includes an electronic control unit (ECU) 1.

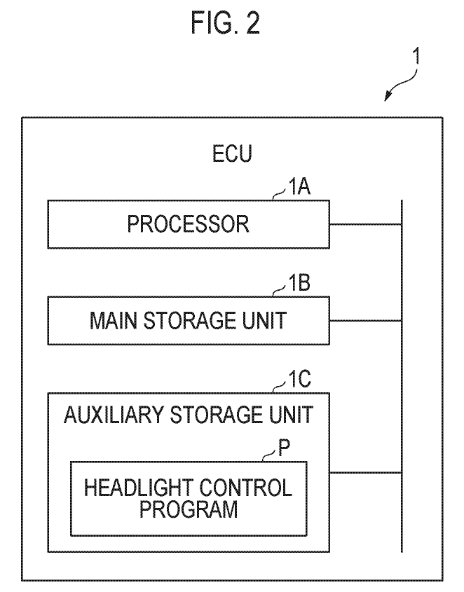

As shown in FIG. 2, the ECU 1 is a computer having a processor 1A, a main storage unit 1B, and an auxiliary storage unit 1C as a hardware configuration. The processor 1A is an arithmetic device that executes a program. Examples of the processor include a central processing unit (CPU), but the type of the processor 1A is not limited thereto. The main storage unit 1B is a device that stores the program, the arithmetic result output from the processor 1A, and the like. The main storage unit 1B is configured by, for example, at least one of a read only memory (ROM) and a random access memory (RAM). The auxiliary storage unit 1C is a device that can store a large amount of data as compared with the main storage unit 1B. The auxiliary storage unit 1C is configured by, for example, a non-volatile storage medium, such as a hard disk or a flash memory. The auxiliary storage unit 1C stores a headlight control program P and various types of data. The headlight control program P is a program that controls the headlamps HL, and causes the ECU 1 (processor 1A) to execute a high-brightness target recognition step, a dimming control step, and a dimming control determination step which will be described below.

As shown in FIG. 1, the ECU 1 has a high-brightness target recognition unit 10, a peripheral environment recognition unit 20, a dimming control determination unit 30, a dimming amount setting unit 40, and a dimming controller 50 as a functional configuration.

The high-brightness target recognition unit 10 recognizes the high-brightness target forward of the vehicle V based on a camera image (captured image) from a camera CA (capturing device) that captures an image of a region forward of the vehicle V. The high-brightness target is a target having a brightness higher than a predetermined brightness, and is not particularly limited. The high-brightness target may be a self-luminous target that emits light by itself, or may be a target that has a high brightness due to reflection of light from the headlamps HL and the like. Examples of the high-brightness target include a signboard, a sign, and another vehicle with its lamps illuminated.

The high-brightness target recognition unit 10 includes a target area calculation unit 11, a target brightness calculation unit 12, and a target coordinate calculation unit 13. The target area calculation unit 11 calculates an area of an object region of the target present forward of the vehicle V on the camera image. The target brightness calculation unit 12 calculates a brightness of the object region of the target present forward of the vehicle V on the camera image. The target coordinate calculation unit 13 calculates coordinates of the target present forward of the vehicle V on the camera image. A method of calculating the area, the brightness, and the coordinates of the target is not particularly limited, and various known methods may be used. The area of the target corresponds to, for example, a size (projected area as viewed from the vehicle V) of the object region occupied by the target on the camera image. The coordinates of the target may be coordinates based on any predetermined position, and correspond to, for example, a position of a point in the object region on the camera image. For example, the high-brightness target recognition unit 10 recognizes the target having a brightness higher than the predetermined brightness that is calculated by the target brightness calculation unit 12, as the high-brightness target, and calculates the area and the coordinates of the high-brightness target by the target area calculation unit 11 and the target coordinate calculation unit 13, respectively. The high-brightness target recognition unit 10 determines whether the brightness of the object region is equal to or greater than a brightness threshold value, and determines whether the area of the object region is equal to or greater than an area threshold value, as a condition for recognizing the high-brightness target.

The peripheral environment recognition unit 20 recognizes a peripheral environment that is an environment around the vehicle V based on the camera image. The peripheral environment recognition unit 20 may include a peripheral illuminance calculation unit 21 that calculates brightness (illuminance) of a road surface and the sky around the vehicle V from the camera image, and a street lamp detection unit 22 that detects positions of a plurality of street lamps around the vehicle V from the camera image. The street lamp is not particularly limited, and may be various known street lamps. A method of calculating the brightness and a method of calculating the position of the street lamp are not particularly limited, and various known methods may be used.

The dimming control determination unit 30 may determine whether the brightness of the peripheral environment of the vehicle V is equal to or greater than a threshold value (brightness suitable for performing the dimming control) based on the camera image. The dimming control determination unit 30 may determine that the brightness of the peripheral environment of the vehicle V is not equal to or greater than the threshold value (not suitable for performing the dimming control) in a case where the peripheral environment of the vehicle V that is recognized from the camera image by the peripheral environment recognition unit 20 is bright enough that the occupant of the vehicle V is unlikely to feel dazzled by the high-brightness target. That is, the dimming control determination unit 30 may determine that the brightness is not suitable for performing the dimming control in a case where the peripheral environment of the vehicle V that is recognized from the camera image by the peripheral environment recognition unit 20 is bright enough that the occupant of the vehicle V is unlikely to feel dazzled by the high-brightness target. The dimming control is control of reducing the amount of light in at least any light distribution region of the plurality of light distribution regions (hereinafter, also simply referred to as “light distribution regions”) in the headlamps HL that includes the high-brightness target.

The dimming control determination unit 30 may determine that the brightness of the peripheral environment is equal to or greater than the threshold value in a case where the brightness of the road surface around the vehicle V is equal to or greater than the threshold value. The dimming control determination unit 30 may determine that the brightness of the peripheral environment is equal to or greater than the threshold value in a case where the brightness of the sky around the vehicle V is equal to or greater than the threshold value. The dimming control determination unit 30 may determine that the brightness of the peripheral environment is equal to or greater than the threshold value in a case where a plurality of street lamps are present around the vehicle V and an interval between the plurality of street lamps is equal to or less than a constant interval. The threshold value may be determined in advance and stored, or may be acquired by communication or the like. The threshold value of the brightness of the road surface and the threshold value of the brightness of the sky may be the same or different from each other. The constant interval may be determined in advance and stored, or may be acquired by communication or the like.

The dimming control determination unit 30 may determine whether a start condition of the dimming control is satisfied based on a position (coordinates) and a size (area) of the high-brightness target recognized by the high-brightness target recognition unit 10. The dimming control determination unit 30 may determine that the start condition of the dimming control is satisfied in a case where the position of the high-brightness target is located in a predetermined range at a center of the camera image and the size of the high-brightness target is equal to or greater than a predetermined size. The predetermined range and the predetermined size are not particularly limited, and may be set in advance and stored in the ECU 1. The predetermined range and the predetermined size may be fixed values or variable values that change depending on various inputs or conditions.

The dimming amount setting unit 40 sets a dimming amount of the dimming control. The dimming amount setting unit 40 may set a predetermined amount (for example, 50%) as the dimming amount. The dimming controller 50 performs the dimming control based on the recognition result of the high-brightness target recognition unit 10. The dimming controller 50 in this case controls the headlamps HL such that the amount of light in one or a plurality of light distribution regions including the high-brightness target recognized by the high-brightness target recognition unit 10 is equal to the dimming amount set by the dimming amount setting unit 40 as the dimming control.

The dimming controller 50 may not perform the dimming control in a case where the dimming control determination unit 30 determines that the brightness of the peripheral environment is not equal to or greater than the threshold value. The dimming controller 50 performs the dimming control in a case where the dimming control determination unit 30 determines that the start condition of the dimming control is satisfied.

Meanwhile, even when the target forward of the vehicle V is bright, the driver (user) of the vehicle may not always feel dazzled depending on the tint of the target. Therefore, the headlight control device 100 performs the dimming control in consideration of the tint of the target.

The high-brightness target recognition unit 10 recognizes a target satisfying a predetermined high-brightness color component condition as the high-brightness target based on a color component of a target included in the camera image. The color component means a component of a color that is decomposed into a plurality of component values to specify the color of the plurality of pixels constituting the target on the camera image. The color component here is, for example, each primary color of RGB. The color component is not limited to RGB, and may be a component used in other known color expression methods. The component value means a gradation value in a predetermined gradation for each component of the color.

The high-brightness color component condition is a condition for determining the high-brightness target in consideration of the color component. The high-brightness color component condition can be a condition for determining whether the occupant of the vehicle V feels dazzled depending on the tint of the target, even in a case where the brightness of the target is higher than the predetermined brightness, based on the component values of the respective color components.

For example, the high-brightness target recognition unit 10 determines whether the high-brightness color component condition is satisfied for each target based on a distribution of each color component of the target included in the camera image. The high-brightness target recognition unit 10 includes a color histogram calculation unit 14 that calculates a color histogram based on the camera image. The color histogram means a histogram in which the number of observations of the component value of the color component in each pixel is counted for a plurality of pixels constituting the target on the camera image. The color histogram calculation unit 14 generates the color histogram for each target.

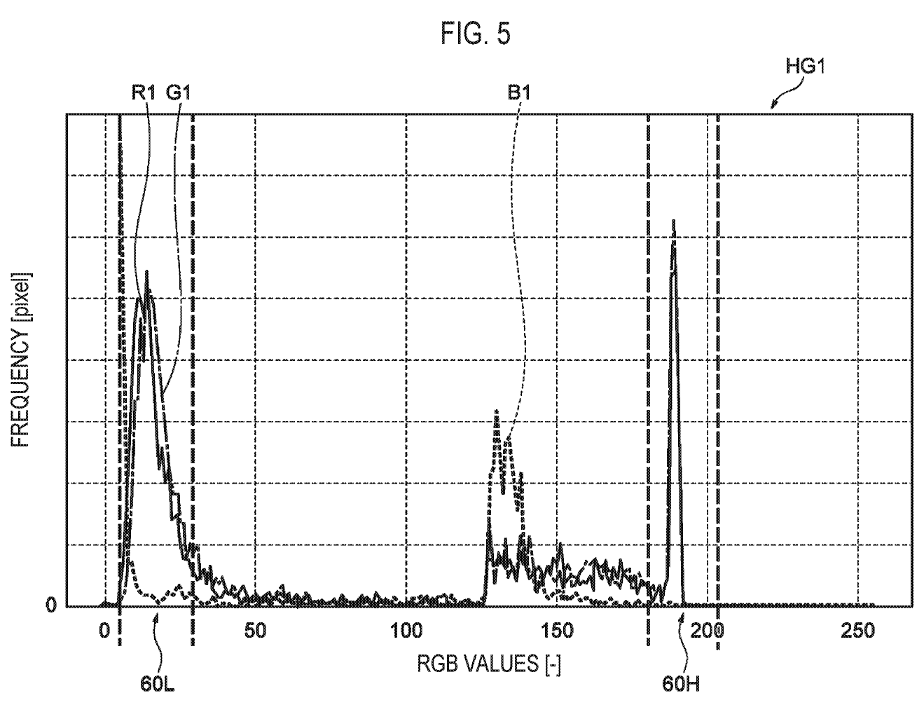

FIG. 5 is a diagram illustrating a histogram in which the number of observations of the component value of the color component is counted. FIG. 5 is a color histogram for a target in which the brightness is higher than the predetermined brightness as the brightness of the target and the occupant of the vehicle V feels dazzled depending on the tint of the target. In FIG. 5, a red component R1 is drawn by a solid line, a green component G1 is drawn by a dash-dot line, and a blue component B1 is drawn by a broken line. A horizontal axis of FIG. 5 represents RGB values, and corresponds to a gradation value in 256 gradations for each of red, green, and blue. A vertical axis of FIG. 5 represents a frequency, and corresponds to the frequency of each gradation value of the red component R1, the green component G1, and the blue component B1.

The high-brightness color component condition is satisfied for a target corresponding to a color histogram in which the total value of the frequencies included in a predetermined range of the component value is equal to or greater than a determination threshold value. The predetermined range is a range of the component value set in advance such that a feature of whether the occupant of the vehicle V feels dazzled depending on the tint of the target appears. The predetermined range includes, for example, a first range 60L that falls within less than half of the number of gradations of the component value and a second range 60H that falls within half or more of the number of gradations of the component value.

The first range 60L is a predetermined range set to classify whether the occupant of the vehicle V feels dazzled and whether the target is a self-luminous target. The first range 60L may be, for example, 0 or more and less than 50 or 5 or more and less than 30 in 256 gradations.

The color histogram calculation unit 14 determines whether the total value of the frequencies included in the first range 60L is equal to or greater than the first determination threshold value. In the example of FIG. 5, the total value of the frequencies included in the first range 60L means a value obtained by totaling the frequency of each gradation value for all gradation values that fall within the first range 60L in each of the red component R1, the green component G1, and the blue component B1. The total value of the frequencies included in the first range 60L corresponds to a total of three areas surrounded by the curve of the red component R1, the curve of the green component G1, and the curve of the blue component B1 included in the first range 60L and the horizontal axis.

The second range 60H is a predetermined range set to classify with higher precision whether the occupant of the vehicle V feels dazzled when the second range 60H is used in combination with the trend of the total value of the frequencies of the first range 60L. The second range 60H may be, for example, 150 or more and less than 255 or 175 or more and less than 210 in 256 gradations.

The color histogram calculation unit 14 determines whether the total value of the frequencies included in the second range 60H is equal to or greater than the second determination threshold value. In the example of FIG. 5, the total value of the frequencies included in the second range 60H means a value obtained by totaling the frequency of each gradation value for all gradation values that fall within the second range 60H in each of the red component R1, the green component G1, and the blue component B1. The total value of the frequencies included in the second range 60H corresponds to a total of three areas surrounded by the curve of the red component R1, the curve of the green component G1, and the curve of the blue component B1 included in the second range 60H and the horizontal axis.

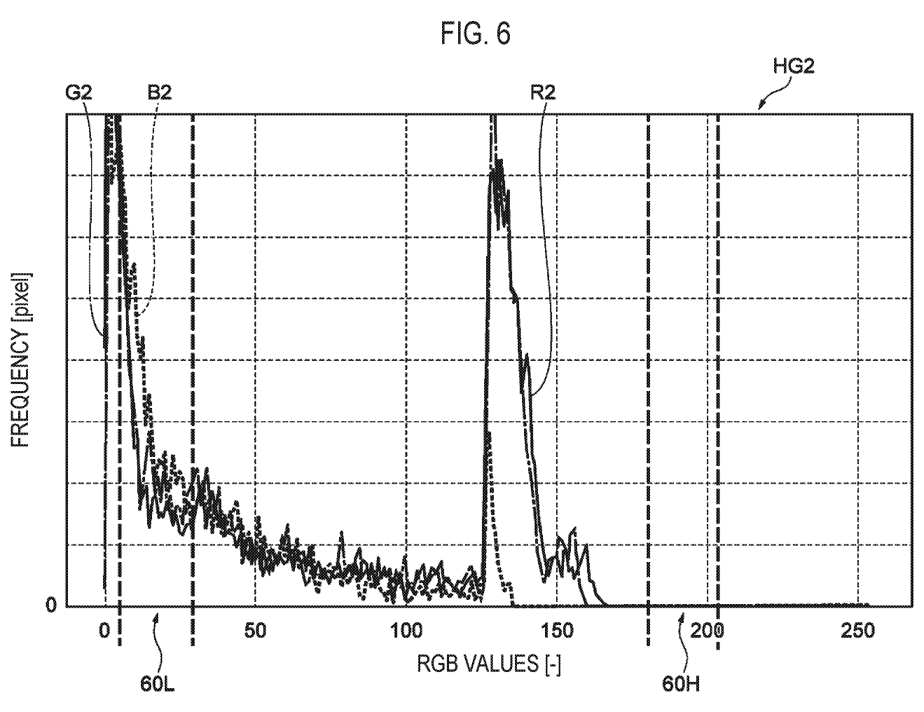

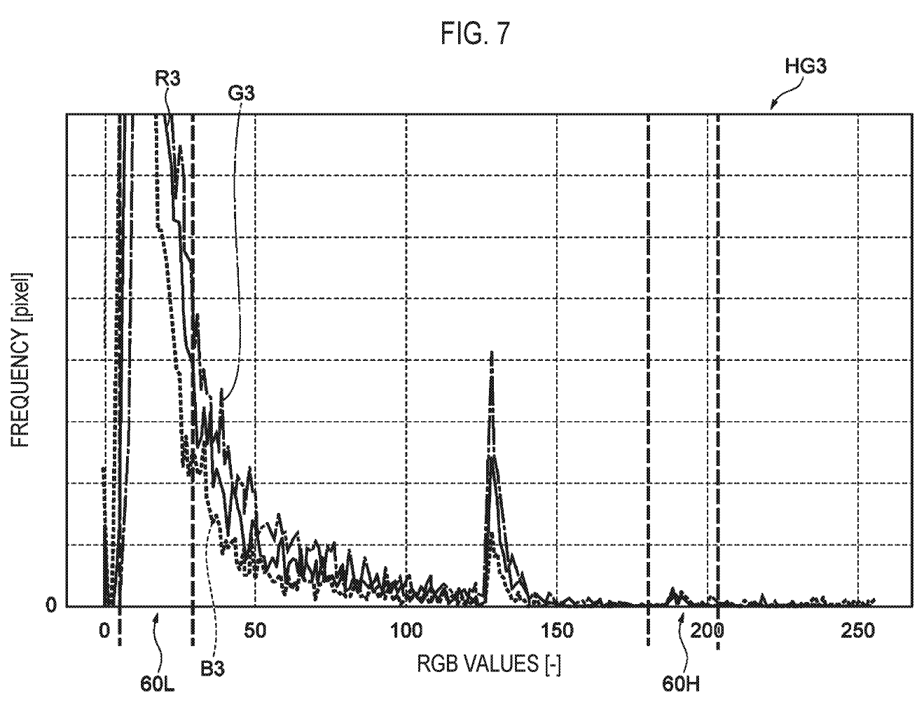

FIG. 6 is a diagram illustrating a histogram of a target different from that of FIG. 5. FIG. 7 is a diagram illustrating a histogram of a target different from those of FIGS. 5 and 6. FIG. 6 is a color histogram for a target in which the brightness is higher than the predetermined brightness as the brightness of the target and the occupant of the vehicle V does not feel dazzled depending on the tint of the target. FIG. 7 is a color histogram for a self-luminous target that emits light by itself. In FIGS. 6 and 7, the horizontal axis and the vertical axis are the same as those of FIG. 5, and the curves of each of the red, green, and blue components are drawn by the same line type as in FIG. 5.

For example, in a color histogram HG1 shown in FIG. 5, the total value of the frequencies included in the first range 60L is equal to or greater than the first determination threshold value, and the total value of the frequencies included in the second range 60H is equal to or greater than the second determination threshold value. The high-brightness target recognition unit 10 recognizes the target corresponding to such a color histogram HG1 as the high-brightness target by determining that the high-brightness color component condition is satisfied. In the example of FIG. 5, a peak of each color component is observed in the second range 60H. As a result, the target corresponding to the color histogram HG1 can be considered to be a high-brightness target that reflects light having a whitish tint and that causes the occupant of the vehicle V to feel dazzled.

For example, in a color histogram HG2 shown in FIG. 6, the total value of the frequencies included in the first range 60L is equal to or greater than the first determination threshold value, and the total value of the frequencies included in the second range 60H is less than the second determination threshold value. The high-brightness target recognition unit 10 does not recognize the target corresponding to such a color histogram HG2 as the high-brightness target by determining that the high-brightness color component condition is not satisfied. In the example of FIG. 6, each color component in the second range 60H is extremely small as compared with FIG. 5. As a result, the target corresponding to the color histogram HG2 can be considered to be a target that reflects light having a tint other than a whitish tint and that does not cause the occupant of the vehicle V to feel dazzled.

For example, as shown in FIG. 7, the high-brightness target recognition unit 10 may recognize a target for which the total value of the frequencies included in the first range 60L is equal to or greater than a third determination threshold value greater than the first determination threshold value as the self-luminous target. The self-luminous target does not exhibit a phenomenon in which the reflected light is reduced even in a case where the dimming control is performed, and the light emitted by itself does not change. Therefore, in this case, the high-brightness target recognition unit 10 may not recognize the target as the high-brightness target.

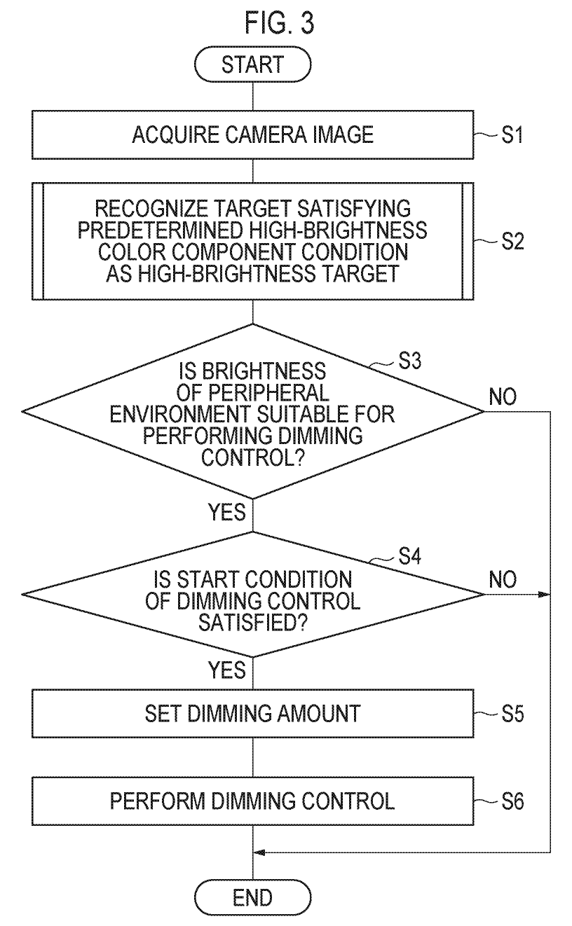

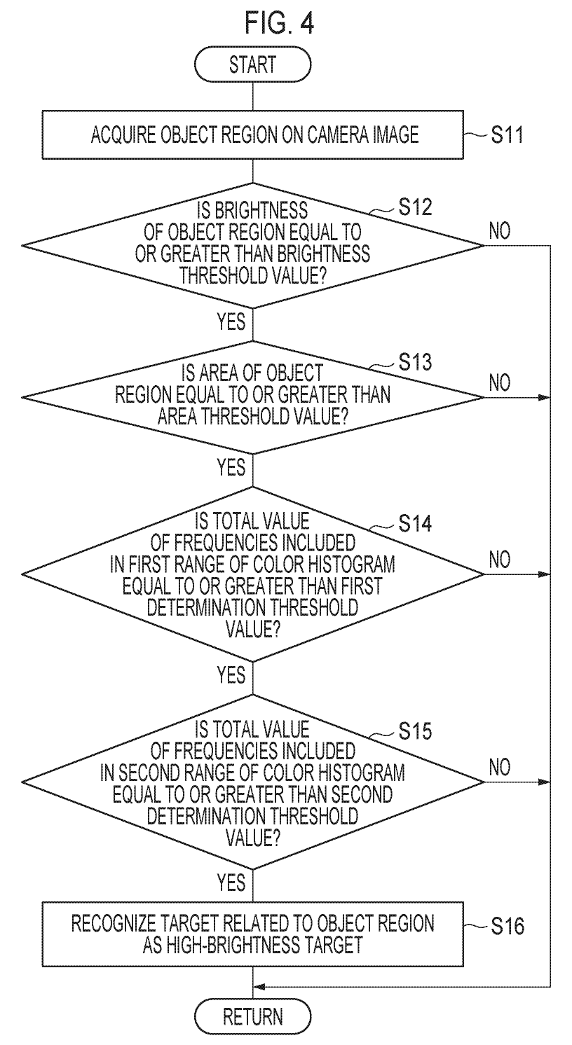

Next, an example of a headlight control method by the headlight control device 100 will be described with reference to the flowcharts of FIGS. 3 and 4. The following series of processing is repeatedly executed at a predetermined interval, for example, in a case where the vehicle V is traveling and the headlamps HL are operating. The headlight control method is a method of controlling the headlamps HL, and corresponds to the processing by the headlight control program P (see FIG. 2).

As shown in FIG. 3, first, in S1, the ECU 1 acquires the camera image from the camera CA. In S2, the ECU 1 causes the high-brightness target recognition unit 10 to recognize, based on the camera image, a target satisfying the predetermined high-brightness color component condition among the targets forward of the vehicle V as the high-brightness target. In S3, the ECU 1 causes the peripheral environment recognition unit 20 to recognize the peripheral environment of the vehicle V based on the camera image. The dimming control determination unit 30 determines whether the brightness of the peripheral environment of the vehicle V recognized by the peripheral environment recognition unit 20 is equal to or greater than the threshold value.

In a case of YES in S3, in S4, the ECU 1 determines whether the start condition of the dimming control is satisfied by the dimming control determination unit 30. In a case of YES in S4, in S5, the ECU 1 sets the dimming amount by the dimming amount setting unit 40. Then, in S6, the ECU 1 performs the dimming control by the dimming controller 50. Meanwhile, in a case of NO in S3 or NO in S4, the ECU 1 ends the processing of FIG. 3 without performing the dimming control.

Specifically, as S2, the ECU 1 executes the processing of FIG. 4. As shown in FIG. 4, in S11, the ECU 1 acquires the object region on the camera image by the high-brightness target recognition unit 10. Next, in S12, the high-brightness target recognition unit 10 determines whether the brightness of the object region is equal to or greater than the brightness threshold value. In a case of YES in S12, in S13, the ECU 1 determines whether the area of the object region is equal to or greater than the area threshold value by the high-brightness target recognition unit 10.

In a case of YES in S13, in S14, the ECU 1 determines whether the total value of the frequencies included in the first range 60L of the color histogram is equal to or greater than the first determination threshold value by the high-brightness target recognition unit 10. In a case of YES in S14, in S15, the ECU 1 determines whether the total value of the frequencies included in the second range 60H of the color histogram is equal to or greater than the second determination threshold value by the high-brightness target recognition unit 10.

In a case of YES in S15, in S16, the ECU 1 recognizes the target (the target corresponding to the color histogram) related to the object region as the high-brightness target by the high-brightness target recognition unit 10. The ECU 1 ends the processing of FIG. 4 and returns to the processing of FIG. 3.

Meanwhile, in a case of NO in any of S12 to S15, the ECU 1 ends the processing of FIG. 4 without recognizing the high-brightness target. The ECU 1 may return to the processing of FIG. 3, end the processing of FIG. 3 for the target, and transition to the processing of FIG. 3 for another target.

S2 corresponds to the high-brightness target recognition step. S3 and S4 correspond to the dimming control determination step. S6 that is not executed in a case of NO in S3 or NO in S4 corresponds to the dimming control step.

In the headlight control device 100 described above, the high-brightness target recognition unit 10 recognizes the target satisfying the predetermined high-brightness color component condition as the high-brightness target. As described above, since the high-brightness target is recognized based on the color components R, G, B of the target included in the camera image, it is possible to suppress the recognition of a target that is bright but that does not cause the occupant to feel dazzled due to the tint of the target as the high-brightness target.

The headlight control device 100 includes the color histogram calculation unit 14 of the high-brightness target recognition unit 10. The color histogram calculation unit 14 generates color histograms HG1 to HG3 for each target by counting the number of observations of the component values of the color components R, G, B in each pixel for a plurality of pixels constituting the target on the camera image. The high-brightness color component condition is satisfied for a target corresponding to a color histogram HG1 in which the total value of the frequencies included in the predetermined ranges 60L, 60H of the component value is equal to or greater than the determination threshold value. As a result, it is possible to determine whether the high-brightness color component condition is satisfied for each target by using the color histograms HG1 to HG3 in which the number of observations of the component values of the color components R, G, B is counted.

In the headlight control device 100, the predetermined range includes the first range 60L that falls within less than half of the number of gradations of the component value and the second range 60H that falls within half or more of the number of gradations of the component value. The high-brightness color component condition is satisfied for a target corresponding to a histogram HG1 in which the total value of the frequencies included in the first range 60L is equal to or greater than the first determination threshold value and the total value of the frequencies included in the second range 60H is equal to or greater than the second determination threshold value. As described above, by performing the determination of the total value of the frequencies in both the first range 60L and the second range 60H having different number of gradations of the component value, it is possible to determine whether the high-brightness color component condition is satisfied with higher precision.

Although the embodiment of the present disclosure has been described above, the present disclosure is not limited to the above-described embodiment. The present disclosure can be implemented in various forms with various changes and improvements based on the knowledge of those skilled in the art, including the above-described embodiment.

In the above-described embodiment, the camera CA is adopted as the capturing device, but the present disclosure is not limited to this, and various known capturing devices may be adopted. In the above-described embodiment, the headlamps HL are adopted as the headlights, but the present disclosure is not limited to this, and various known headlights may be adopted.

In the above-described embodiment, both the first range and the second range are used, but any one of the first range and the second range may be used. In addition, it is not mandatory to set the predetermined range of the component value, and the entire component value may be used by performing weighting according to the gradation value, for example.

In the above-described embodiment, the color histogram calculation unit 14 generates the color histogram, but the present disclosure is not limited to this method. In short, the high-brightness target recognition unit 10 may recognize the target satisfying the predetermined high-brightness color component condition as the high-brightness target based on the color component of the target included in the camera image.

What is claimed is:

1. A headlight control device that controls headlights being able to adjust an amount of light for each of a plurality of light distribution regions, the headlight control device comprising:
a high-brightness target recognition unit configured to recognize a high-brightness target forward of a vehicle based on a captured image from a capturing device that captures an image of a region forward of the vehicle; and
a dimming controller configured to perform, based on a recognition result of the high-brightness target recognition unit, dimming control of reducing an amount of light in a light distribution region that includes the high-brightness target,
wherein the high-brightness target recognition unit is configured to recognize, based on a color component of a target included in the captured image, the target satisfying a predetermined high-brightness color component condition as the high-brightness target.

2. The headlight control device according to claim 1, wherein:
the high-brightness target recognition unit is configured to generate, for a plurality of pixels constituting the target on the captured image, for each of the targets, a histogram in which the number of observations of a component value of the color component in each of the pixels is counted; and
the high-brightness color component condition is satisfied for a target corresponding to a histogram in which a total value of frequencies included in a predetermined range of the component value is equal to or greater than a determination threshold value.

3. The headlight control device according to claim 2, wherein:
the predetermined range includes a first range falling within less than half of the number of gradations of the component value and a second range falling within half or more of the number of gradations of the component value; and
the high-brightness color component condition is satisfied for a target corresponding to a histogram in which a total value of frequencies included in the first range is equal to or greater than a first determination threshold value and a total value of frequencies included in the second range is equal to or greater than a second determination threshold value.
